(19) United States
(12) Patent Application Publication
(10) Pub. No.: US 2026/0260803 A1
(43) Pub. Date: Sep. 3, 2026

(54) ELECTRONIC COMPONENT AND CIRCUIT MODULE EQUIPPED WITH SAME

(71) Applicant: TDK CORPORATION, Tokyo (JP)

(72) Inventors: Kazuhiro YOSHIKAWA, Tokyo (JP); Keigo HIGASHIDA, Tokyo (JP); Koichi TSUNODA, Tokyo (JP)

(21) Appl. No.: 19/491,262

(22) PCT Filed: May 21, 2024
(86) PCT No.: PCT/JP2024/018609

§ 371 Date: Dec. 8, 2025

(30) Foreign Application Priority Data
Jun. 9, 2023 (JP) 2023-095558

(51) Int. Cl. H01F 27/28; H01F 27/29

(52) U.S. Cl. CPC H01F 27/2804; H01F 27/292; H01F 2027/2809

(57) ABSTRACT

A coil component includes a coil C1 connected between electrodes E1 and E2, and a coil C2 connected between electrodes E3 and E4. The coil C1 includes a conductor pattern 11 extending in the X-direction, a conductor pattern 12 connected between the electrode E1 and one end of the conductor pattern 11, and a conductor pattern 13 connected between the electrode E2 and the other end of the conductor pattern 11. The coil C2 includes a conductor pattern 24 extending in the X-direction, a conductor pattern 25 connected between the electrode E3 and one end of the conductor pattern 24, and a conductor pattern 26 connected between the electrode E4 and the other end of the conductor pattern 24. The coils C1 and C2 are arranged adjacent to each other in the Y-direction, and the conductor patterns 11 and 24 are formed at mutually different positions in the X-direction.

### TECHNICAL FIELD

The present disclosure relates to an electronic component and a circuit module having the same.

### BACKGROUND ART

Patent Documents 1 and 2 each disclose a coil component in which a coil array is incorporated in an element body. The coil component disclosed in Patent Document 1 is a coil component in which the coil axis of each coil is perpendicular to a mounting surface. The coil component disclosed in Patent Document 2 is a coil component in which the coil axis of each coil is parallel to a mounting surface.

### CITATION LIST

### Patent Document

[Patent Document 1] JP 2023-006821A
[Patent Document 2] JP 2022-026520A

### DISCLOSURE OF THE INVENTION

### Problem to be Solved by the Invention

In the coil component disclosed in Patent Document 1, the coil axis of each coil is perpendicular to a mounting surface, so that the mounting area is disadvantageously large. In the coil component disclosed in Patent Document 2, the coil axis of each coil is parallel to a mounting surface, SO that the required number of layers to be stacked disadvantageously increases in proportion to the number of coils to be incorporated.

The present disclosure describes an improved electronic component including a plurality of coils and a circuit module having such an electronic component.

### Means for Solving the Problem

An electronic component according an aspect of the present disclosure includes: an element body having first and second surfaces extending in a first direction and a second direction perpendicular to the first direction, the first surface being different in position in a third direction perpendicular to the first and second directions from the second surface; first and second terminal electrodes formed on the first surface and arranged in the first direction; third and fourth terminal electrodes formed on the first surface and arranged in the first direction; a first coil having one end electrically connected to the first terminal electrode and the other end electrically connected to the second terminal electrode; and a second coil having one end electrically connected to the third terminal electrode and the other end electrically connected to the fourth terminal electrode. The first coil includes: a first conductor pattern formed on the first surface so as to extend in the first direction and having one end positioned on the first terminal electrode side and the other end positioned on the second terminal electrode side; a second conductor pattern formed on the second surface and having one end electrically connected to the first terminal electrode and the other end electrically connected to the other end of the first conductor pattern; and a third conductor pattern formed on the second surface and having one end electrically connected to the second terminal electrode and the other end electrically connected to the one end of the first conductor pattern. The second coil includes: a fourth conductor pattern formed on the first surface so as to extend in the first direction and having one end positioned on the third terminal electrode side and the other end positioned on the fourth terminal electrode side; a fifth conductor pattern formed on the second surface and having one end electrically connected to the third terminal electrode and the other end electrically connected to the other end of the fourth conductor pattern; and a sixth conductor pattern formed on the second surface and having one end electrically connected to the fourth terminal electrode and the other end electrically connected to the one end of the fourth conductor pattern. The first coil and the second coil are arranged adjacent to each other in the second direction, and the first conductor pattern and the fourth conductor pattern are formed at mutually different positions in the first direction.

A circuit module according to an aspect of the present disclosure includes a substrate having first to fourth land patterns and the above-described electronic component mounted on the substrate, and the first to fourth terminal electrodes of the electronic component are connected respectively to the first to fourth land patterns.

### Advantageous Effects of the Invention

According to the present disclosure, an improved electronic component including a plurality of coils and a circuit module having such an electronic component can be provided.

### BRIEF DESCRIPTION OF THE DRAWINGS

FIG. 1 is a schematic transparent perspective view illustrating the outer appearance of a coil component 100 according to an embodiment of the technology described herein.

FIG. 2 is a schematic transparent top view of the coil component 100.

FIG. 3 is a schematic transparent side view of the coil component 100.

FIG. 4 is a schematic bottom view of the coil component 100.

FIG. 5 is a schematic exploded perspective view of a circuit module 200 including the coil component 100.

FIG. 6 is a schematic transparent top view of the coil component according to a modification.

FIG. 7 is a schematic transparent side view of the coil component according to the modification.

FIG. 8 is a schematic bottom view of the coil component the modification.

### MODE FOR CARRYING OUT THE INVENTION

Hereinafter, some embodiments of the present disclosure will be explained in detail with reference to the accompanying drawings.

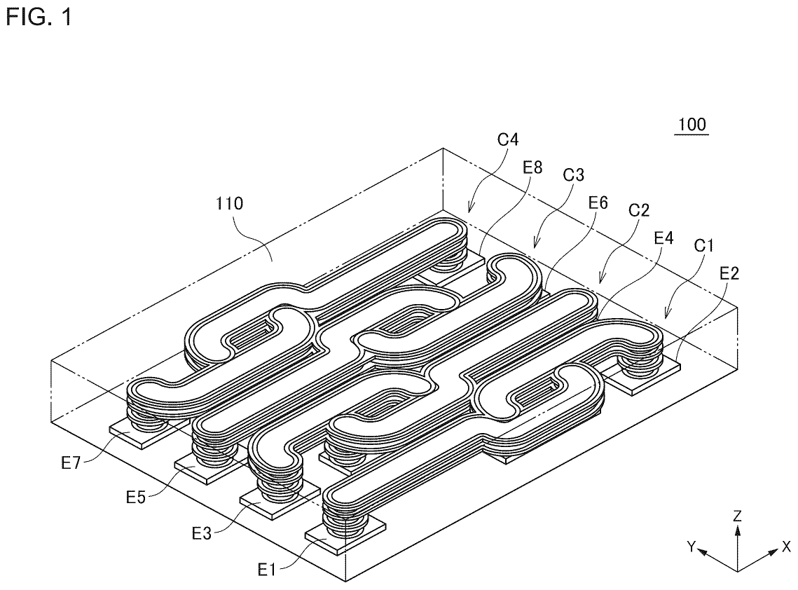

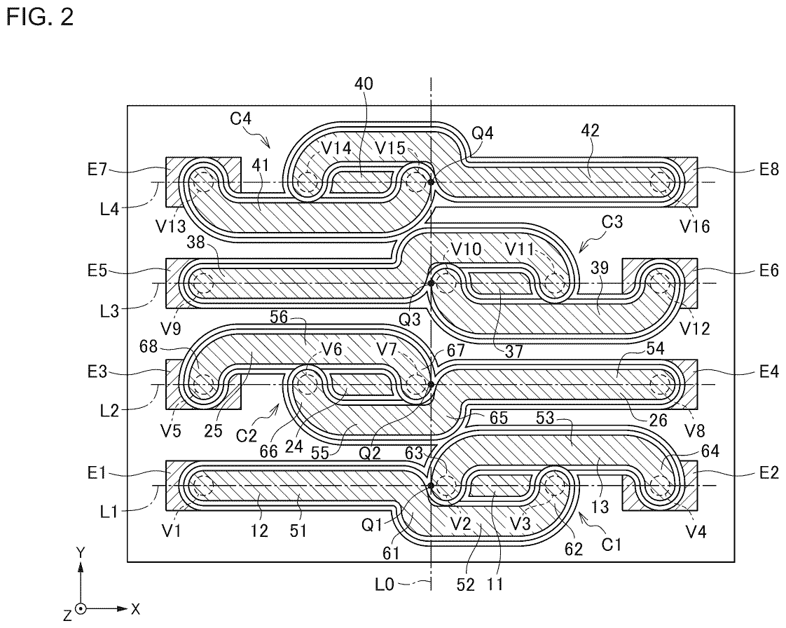

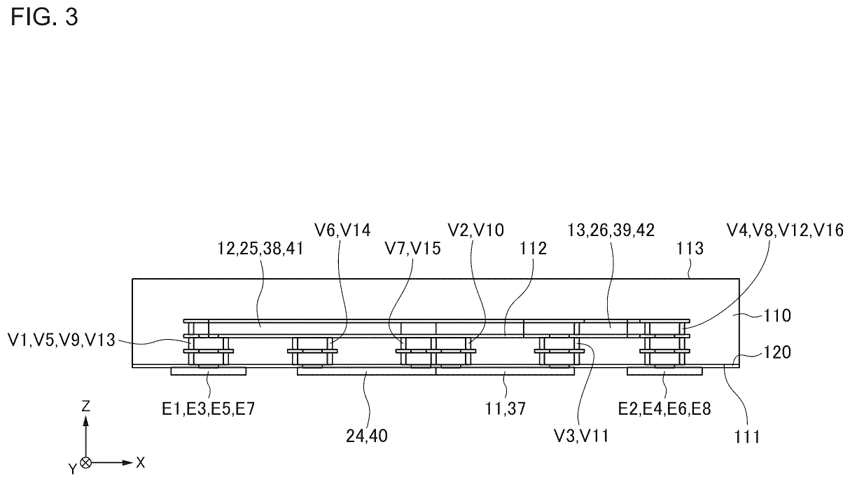

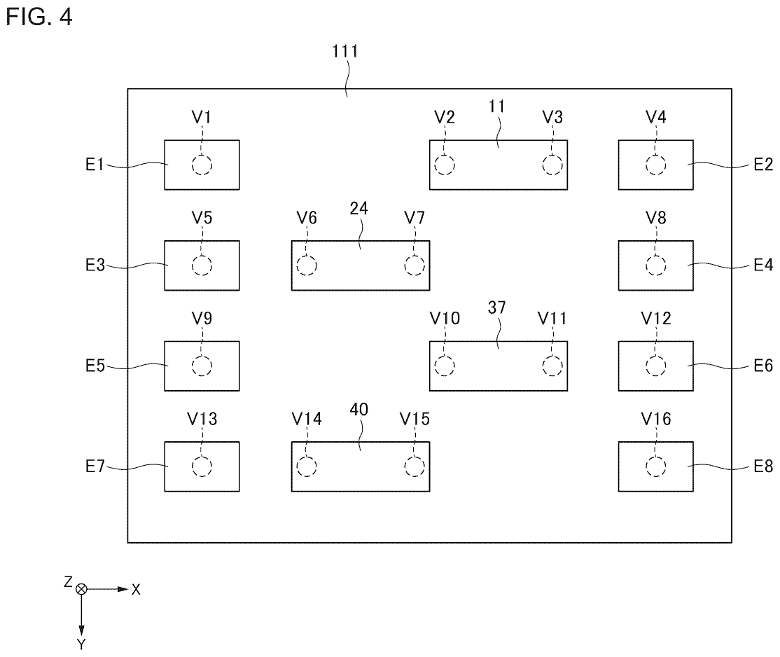

FIG. 1 is a schematic transparent perspective view illustrating the outer appearance of an electronic component (coil component) 100 according to an embodiment of the technology described herein. FIG. 2 is a schematic transparent top view of the coil component 100, FIG. 3 is a schematic transparent side view of the coil component 100, and FIG. 4 is a schematic bottom view of the coil component 100.

As illustrated in FIGS. 1 to 4, the coil component 100 according to the present embodiment includes an element body 110, four coils C1 to C4 embedded in the element body 110, and terminal electrodes E1 to E8 exposed to one surface of the element body 110. The element body 110 may be a composite magnetic material obtained by binding, with binder resin, magnetic particles made of a high permeability material such as ferrite or permalloy. As illustrated in FIG. 3, the element body 110 has outer surfaces 111, 113 and an inner layer surface 112. The outer surfaces 111, 113 and inner layer surface 112 constitute the XY plane and differ in position in the Z-direction. The outer surface 111 serves as a mounting surface of the coil component 100. The outer surface 111 has thereon eight terminal electrodes E1 to E8. The outer surface 111 may be covered with a protective film 120 made of resin or the like. The outer surface 113 is a surface (upper surface) positioned on the opposite side of the outer surface 111. The inner layer surface 112 is a surface positioned inside the element body 110 and is not exposed outside.

Hereinafter, a direction directed from the terminal electrode E1 toward the terminal electrode E2 is sometimes referred to as “X-direction (or positive X-direction) ”, and its opposite direction is as “negative X-direction”. Similarly, a direction directed from the terminal electrode E1 toward the terminal electrode E7 is sometimes referred to as “Y-direction (or positive Y-direction)”, and its opposite direction is as “negative Y-direction”. Further, a direction directed from the outer surface 111 toward the outer surface 113 is sometimes referred to as “Z-direction (or positive Z-direction)”, and its opposite direction is as “negative Z-direction”. In the specific example illustrated in FIGS. 1 to 4, the X-, Y-, and Z-directions are mutually perpendicular. Note that even a case in which the angles formed between the X- and Y-directions, X- and Z-directions, and Y-and Z-directions differ from the right angle due to manufacturing error or the like in the coil component 100 (e. g., differ from the right angle by about 5°) is included in the present disclosure.

As illustrated in FIG. 4, not only the terminal electrodes E1 to E8 but also conductor patterns 11, 24, 37, and 40 are exposed to the outer surface 111. The terminal electrode E1 to E8 and conductor patterns 11, 24, 37, and 40 are positioned in the same conductor layer. The conductor patterns 11, 24, 37, and 40 are not external terminals, and thus they may each be covered with an insulating film such as a resin film. Further, as illustrated in FIG. 4, the terminal electrodes E1 and E2 are arranged in the X-direction, and the conductor pattern 11 extending in the X-direction is positioned therebetween. The terminal electrodes E3 and E4 are arranged in the X-direction, and the conductor pattern 24 extending in the X-direction is positioned therebetween. The terminal electrodes E7 and E8 are arranged in the X-direction, and the conductor pattern 40 extending in the X-direction is positioned therebetween.

In the example illustrated in FIGS. 1 to 4, the terminal electrodes E1, E3, E5, and E7 are arranged in the Y-direction, and the terminal electrodes E2, E4, E6, and E8 are arranged in the Y-direction. This can reduce the size of the element body 110 in the X-direction.

In the example illustrated in FIGS. 1 to 4, the positions of the conductor patterns 11 and 37 in the X-direction may be the same as each other, and the positions of the conductor patterns 24 and 40 in the X-direction may be the same as each other. The position of the conductor patterns 11 and 37 in the X-direction and position of the conductor patterns 24 and 40 in the X-direction are different from each other. That is, in the example illustrated in FIG. 4, the position of the conductor patterns 11, 37 and position of the conductor patterns 24, 40 do not overlap each other in the X-direction. The edge position of the conductor patterns 11 and 37 in the negative X-direction (on the formation side of the terminal electrodes E1, E3, E5, and E7 in FIG. 4) and the edge position of the conductor patterns 24 and 40 in the positive X-direction (on the formation side of the terminal electrodes E2, E4, E6, and E8 in FIG. 4) may substantially coincide with each other. However, the present disclosure is not limited to this, but the position of the conductor patterns 11, 37 and position of the conductor patterns 24, 40 may partially overlap each other in the X-direction.

The coil C1 is connected between the terminal electrodes E1 and E2. One end of the coil C1 is electrically connected to the terminal electrode E1, and the other end thereof is electrically connected to the terminal electrode E2. The coil C1 has a conductor pattern 11 positioned in the outer surface 111, conductor patterns 12 and 13 positioned in the inner layer surface 112, and via conductors V1 to V4 penetrating between the outer surface 111 and inner layer surface 112. The via conductors V1 to V4 may be arranged in this order in the X-direction. The conductor pattern 11 linearly extends in the X-direction, while the conductor patterns 12 and 13 extend in the X-direction while meandering in the Y-Direction.

In the aspect illustrated in FIG. 2, in a plan view as viewed in the Z-direction, the conductor pattern 12 has a first linear part 51 which is linearly formed in the X-direction and whose end portion in the negative X-direction is connected to the via conductor V1. The conductor pattern 12 further has a second linear part 52 which linearly extends in the X-direction, whose end portion in the negative X-direction is connected to the end portion of the first linear part 51 in the positive X-direction through a first bent part 61, and whose end portion in the positive X-direction is connected to the via conductor V3 through a second bent part 62. The first bent part 61 illustrated in FIG. 2 may include, from the via conductor V1 toward the via conductor V3, a bend from the negative X-direction side toward the negative Y-direction side and a bend from the positive Y-direction side toward the positive X-direction side. The second bent part 62 illustrated in FIG. 2 may include, from the via conductor V1 toward the via conductor V3, a bend from the negative X-direction side toward the positive Y-direction side. In the aspect illustrated in FIG. 2, the conductor pattern 13 further has a third linear part 53 which linearly extends in the X-direction, whose end portion in the negative X-direction is connected to the via conductor V2 through a third bent part 63, and whose end portion in the positive X-direction is connected to the via conductor V4 through a fourth bent part 64.

One end of the conductor pattern 12 in the negative X-direction is connected to the terminal electrode El through the via conductor V1. One end of the conductor pattern 13 in the positive X-direction is connected to the terminal electrode E2 through the via conductor V4. One end of the conductor pattern 11 on the terminal electrode E1 side (negative X-direction side) is connected to the other end of the conductor pattern 13 through the via conductor V2. The other end of the conductor pattern 11 on the terminal electrode E2 side (positive X-direction side) is connected to the other end of the conductor pattern 12 through the via conductor V3.

Thus, current externally input to the terminal electrode E1 flows to the terminal electrode E2 through the via conductor V1, conductor pattern 12, via conductor V3, conductor pattern 11, via conductor V2, conductor pattern 13, and via conductor V4. Here, current flows mainly in the positive X-direction in the conductor patterns 12 and 13, whereas it flows in the negative X-direction in the conductor pattern 11. Further, current flows in the negative Z-direction in the via conductor V3, whereas it flows in the positive Z-direction in the via conductor V2. As a result, the conductor pattern 12, via conductor V3, conductor pattern 11, via conductor V2, and conductor pattern 13 constitute a loop having its axis extending in the Y-direction. The area surrounded by the loop as viewed in the Y-direction is filled with the element body 110 and becomes an area (inductor core) where magnetic flux occurs when current flows in the coil C1. Further, in a plan view as viewed in the Z-direction, the area surrounded by the conductor patterns 12 and 13 overlaps a part of the conductor pattern 11.

The coil C2 is disposed adjacent to the coils C1 and C3 so as to be sandwiched between the coils C1 and C2 in the Y-direction and is connected between the terminal electrodes E3 and E4. One end of the coil C2 is electrically connected to the terminal electrode E3, and the other end thereof is electrically connected to the terminal electrode E4. The coil C2 has a conductor pattern 24 positioned in the outer surface 111, conductor patterns 25 and 26 positioned in the inner layer surface 112, and via conductors V5 to V8 penetrating between the outer surface 111 and inner layer surface 112. The via conductors V5 to V8 may be arranged in this order in the X-direction. The conductor pattern 24 linearly extends in the X-direction, while the conductor patterns 25 and 26 extend in the X-direction while meandering in the Y-direction.

In the aspect illustrated in FIG. 2, in a plan view as viewed in the Z-direction, the conductor pattern 26 has a fourth linear part 54 which is linearly formed in the X-direction and whose end portion in the positive X-direction is connected to the via conductor V8. The conductor pattern 26 further has a fifth linear part 55 which linearly extends in the X-direction, whose end portion in the positive X-direction is connected to the end portion of the fourth linear part 54 in the negative X-direction through a fifth bent part 65, and whose end portion in the negative X-direction is connected to the via conductor V6 through a sixth bent part 66. The fifth bent part 65 illustrated in FIG. 2 may include, from the via conductor V8 toward the via conductor V6, a bend from the positive X-direction side toward the negative Y-direction side and a bend from the positive Y-direction side toward the negative X-direction side. The sixth bent part 66 illustrated in FIG. 2 may include, from the via conductor V8 toward the via conductor V6, a bend from the positive X-direction side toward the positive Y-direction side. In the aspect illustrated in FIG. 2, the conductor pattern 25 further has a sixth linear part 56 which linearly extends in the X-direction, whose end portion in the positive X-direction is connected to the via conductor V7 through a seventh bent part 67, and whose end portion in the negative X-direction is connected to the via conductor V5 through an eighth bent part 68.

One end of the conductor pattern 25 in the negative X-direction is connected to the terminal electrode E3 through the via conductor V5. One end of the conductor pattern 26 in the positive X-direction is connected to the terminal electrode E4 through the via conductor V8. One end of the conductor pattern 24 on the terminal electrode E3 side (negative X-direction side) is connected to the other end of the conductor pattern 26 through the via conductor V6. The other end of the conductor pattern 24 on the terminal electrode E4 side (positive X-direction side) is connected to the other end of the conductor pattern 25 through the via conductor V7.

Thus, current externally input to the terminal electrode E3 flows to the terminal electrode E4 through the via conductor V5, conductor pattern 25, via conductor V7, conductor pattern 24, via conductor V6, conductor pattern 26, and via conductor V8. Here, current flows mainly in the positive X-direction in the conductor patterns 25 and 26, whereas it flows in the negative X-direction in the conductor pattern 24. Further, current flows in the negative Z-direction in the via conductor V7, whereas it flows in the positive Z-direction in the via conductor V6. As a result, the conductor pattern 25, via conductor V7, conductor pattern 24, via conductor V6, and conductor pattern 26 constitute a loop having its axis extending in the Y-direction. The portion surrounded by the loop becomes an area (inductor core) where magnetic flux occurs when current flows in the coil C2. The area surrounded by the loop as viewed in the Y-direction is filled with the element body 110. Further, in a plan view as viewed in the Z-direction, the area surrounded by the conductor patterns 25 and 26 overlaps a part of the conductor pattern 24.

The coil C3 is disposed adjacent to the coils C2 and C4 so as to be sandwiched between the coils C2 and C4 in the Y-direction and is connected between the terminal electrodes E5 and E6. One end of the coil C3 is electrically connected to the terminal electrode E5, and the other end thereof is electrically connected to the terminal electrode E6. The coil C3 has a conductor pattern 37 positioned in the outer surface 111, conductor patterns 38 and 39 positioned in the inner layer surface 112, and via conductors V9 to V12 penetrating between the outer surface 111 and inner layer surface 112. The via conductors V9 to V12 may be arranged in this order in the X-direction. The conductor pattern 37 linearly extends in the X-direction, while the conductor patterns 38 and 39 extend in the X-direction while meandering in the Y-direction.

The conductor pattern 38 has two linear parts and two bent parts like the conductor pattern 12. The conductor pattern 39 has one linear part and two bent parts like the conductor pattern 13. One end of the conductor pattern 38 in the negative X-direction is connected to the terminal electrode E5 through the via conductor V9. One end of the conductor pattern 39 in the positive X-direction is connected to the terminal electrode E6 through the via conductor V12. One end of the conductor pattern 37 on the terminal electrode E5 side (negative X-direction side) is connected to the other end of the conductor pattern 39 through the via conductor V10. The other end of the conductor pattern 37 on the terminal electrode E6 side (positive X-direction side) is connected to the other end of the conductor pattern 38 through the via conductor V11.

Thus, current externally input to the terminal electrode E5 flows to the terminal electrode E6 through the via conductor V9, conductor pattern 38, via conductor V11, conductor pattern 37, via conductor V10, conductor pattern 39, and via conductor V12. Here, current flows mainly in the positive X-direction in the conductor patterns 38 and 39, whereas it flows in the negative X-direction in the conductor pattern 37. Further, current flows in the negative Z-direction in the via conductor V11, whereas it flows in the positive Z-direction in the via conductor V10. As a result, the conductor pattern 38, via conductor V11, conductor pattern 37, via conductor V10, and conductor pattern 39 constitute a loop having its axis extending in the Y-direction. The portion surrounded by the loop becomes an area (inductor core) where magnetic flux occurs when current flows in the coil C3. The area surrounded by the loop as viewed in the Y-direction is filled with the element body 110. Further, in a plan view as viewed in the Z-direction, the area surrounded by the conductor patterns 38 and 39 overlaps a part of the conductor pattern 37.

The coil C4 is disposed adjacent to the coil C3 in the Y-direction and connected between the terminal electrodes E7 and E8. One end of the coil C4 is electrically connected to the terminal electrode E7, and the other end thereof is electrically connected to the terminal electrode E8. The coil C4 has a conductor pattern 40 positioned in the outer surface 111, conductor patterns 41 and 42 positioned in the inner layer surface 112, and via conductors V13 to V16 penetrating between the outer surface 111 and inner layer surface 112. The via conductors V13 to V16 may be arranged in this order in the X-direction. The conductor pattern 40 linearly extends in the X-direction, while the conductor patterns 41 and 42 extend in the X-direction while meandering in the Y-direction.

The conductor pattern 41 has one linear part and two bent parts like the conductor pattern 25. The conductor pattern 42 has two linear parts and two bent parts like the conductor pattern 26. One end of the conductor pattern 41 in the negative X-direction is connected to the terminal electrode E7 through the via conductor V13. One end of the conductor pattern 42 in the positive X-direction is connected to the terminal electrode E8 through the via conductor V16. One end of the conductor pattern 40 on the terminal electrode E7 side (negative X-direction side) is connected to the other end of the conductor pattern 42 through the via conductor V14. The other end of the conductor pattern 40 on the terminal electrode E8 side (positive X-direction side) is connected to the other end of the conductor pattern 41 through the via conductor V15.

Thus, current externally input to the terminal electrode E7 flows to the terminal electrode E8 through the via conductor V13, conductor pattern 41, via conductor V15, conductor pattern 40, via conductor V14, conductor pattern 42, and via conductor V16. Here, current flows mainly in the positive X-direction in the conductor patterns 41 and 42, whereas it flows in the negative X-direction in the conductor pattern 40. Further, current flows in the negative Z-direction in the via conductor V15, whereas it flows in the positive Z-direction in the via conductor V14. As a result, the conductor pattern 41, via conductor V15, conductor pattern 40, via conductor V14, and conductor pattern 42 constitute a loop having its axis extending in the Y-direction. The portion surrounded by the loop becomes an area (inductor core) where magnetic flux occurs when current flows in the coil C4. The area surrounded by the loop as viewed in the Y-direction is filled with the element body 110. Further, in a plan view as viewed in the Z-direction, the area surrounded by the conductor patterns 41 and 42 overlaps a part of the conductor pattern 40.

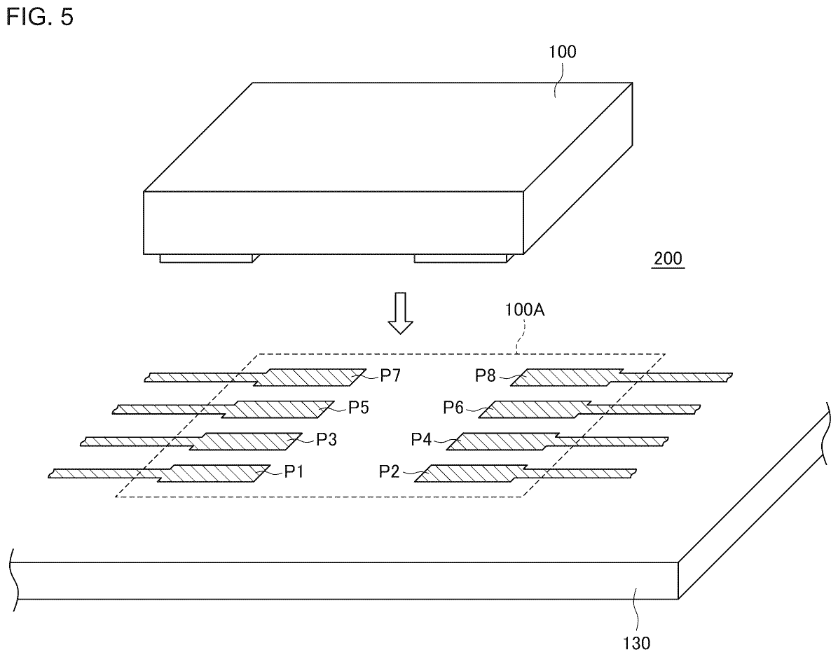

With the above configuration, the coil component 100 according to the present embodiment constitutes eight-terminal type coil array incorporating four coils. The coil component 100 is mounted on a mounting area 100A of a substrate 130 illustrated in FIG. 5, whereby a circuit module 200 can be obtained. The substrate 130 has land patterns P1 to P8 on its surface, and the coil component 100 is mounted on the substrate 130 such that the terminal electrodes E1 to E8 are connected respectively to the land patterns P1 to P8.

In the coil component 100 according to the present embodiment, the coils C1 to C4 are arranged in the Y-direction and each have a loop having its axis extending in the Y-direction, so that the size of the element body 110 in the Y-direction can be reduced. In particular, in two coils adjacent in the Y-direction, the positions of the conductor patterns exposed to the outer surface 111 in the X-direction differ from each other, so that, sections each in which the coil patterns provided in the inner layer surface 112 overlap each other in the Y-direction can be shifted in the X-direction between the two adjacent coils. Specifically, for example, a section in which the conductor patterns 12 and 13 of the coil C1 overlap each other in the Y-direction and a section in which the conductor patterns 25 and 26 of the coil C2 overlap each other in the Y-direction can be shifted from each other in the X-direction. This allows a plurality of coils to be incorporated in the element body 110 with higher density.

In addition, the conductor patterns provided inside the element body 110 are stacked in the Z-direction, the number of the conductor patterns to be stacked does not increase even with an increase in the number of coils to be incorporated in the element body 110, resulting in manufacturing cost reduction.

As illustrated in FIG. 2, when a virtual line LO that passes through the center of the coils C1 to C4 in the X-direction and extends in the Y-direction is defined, the conductor patterns 12 and 13 constituting the coil C1 and conductor patterns 25 and 26 constituting the coil C2 are line-symmetric with the virtual line LO as the symmetry axis, and the conductor patterns 38 and 39 constituting the coil C3 and conductor patterns 41 and 42 constituting the coil C4 are line-symmetric with the virtual line LO as the symmetry axis. That is, when the conductor patterns 12 and 13 of the coil C1 are inverted with the virtual line as the symmetry axis, they coincide with the shape formed by the conductor patterns 25 and 26 of the coil C2, and similarly, when the conductor patterns 38 and 39 of the coil C3 are inverted with the virtual line as the symmetry axis, they coincide with the shape formed by the conductor patterns 41 and 42 of the coil C4.

Further, when virtual line L1 to L4 that pass through the centers of the coils C1 to C4 in the Y-direction and extend in the X-direction are defined, the conductor patterns 12 and 13 constituting the coil C1 and the conductor patterns 38 and 39 constituting the coil C3 are line-symmetric with the virtual lines L1 and L3 as symmetry axes, and the conductor patterns 25 and 26 constituting the coil C2 and the conductor patterns 41 and 42 constituting are line-symmetric with the virtual lines L2 and L4 as symmetry axes. That is, the shape obtained by inverting the conductor patterns 12 and 13 of the coil C1 with the virtual line L1 as the symmetry axis coincides with the shape constituted by the conductor patterns 38 and 39 of the coil C3, and the shape obtained by inverting the conductor patterns 38 and 39 of the coil C3 with the virtual line L3 as the symmetry axis coincides with the shape constituted by the conductor patterns 12 and 13 of the coil C1. Similarly, the shape obtained by inverting the conductor patterns 25 and 26 of the coil C2 with the virtual line L2 as the symmetry axis coincides with the shape constituted by the conductor patterns 41 and 42 of the coil C4, and the shape obtained by inverting the conductor patterns 41 and 42 of the coil C4 with the virtual line L4 as the symmetry axis coincides with the shape constituted by the conductor patterns 25 and 26 of the coil C2. In other words, the conductor patterns 38 and 39 of the coil C3 may be formed so as to have the same linear part and same bent part as those of the respective conductor patterns 12 and 13 of the coil C1, and the conductor patterns 41 and 42 of the coil C4 may be formed so as to have the same linear part and same bent part as those of the respective conductor patterns 25 and 26 of the coil C2.

Further, when intersections between the virtual line LO and virtual lines L1 to L4 are defined as Q1 to Q4, the coils C1 and C4 are point-symmetric with the intersections Q1 and 04 as center points, and the coils C2 and C3 are point-symmetric with the intersections Q2 and Q3 as center points. That is, a shape obtained by rotating the coil C1 by 180° with the intersection Q1 as the center point coincides with the shape of the coil C4, and a shape obtained by rotating the coil C4 by 180° with the intersection Q4 as the center point coincides with the shape of the coil C1. Similarly, a shape obtained by rotating the coil C2 by 180° with the intersection Q2 as the center point coincides with the shape of the coil C3, and a shape obtained by rotating the coil C3 by 180° with the intersection Q3 as the center point coincides with the shape of the coil C2.

Since the coils C1 to C4 are thus configured, it is possible to arrange the coils C1 to C4 mutually having the same inductance with high density and to facilitate pattern design of the conductor patterns.

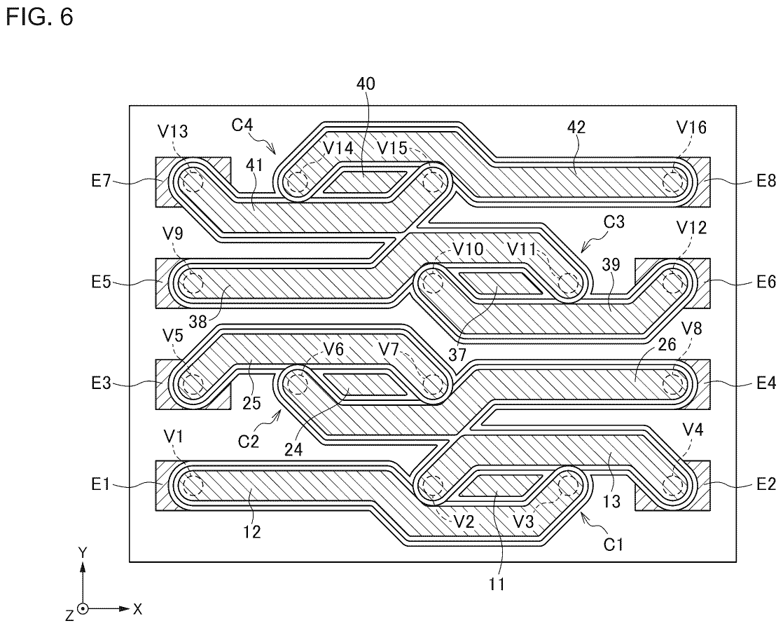

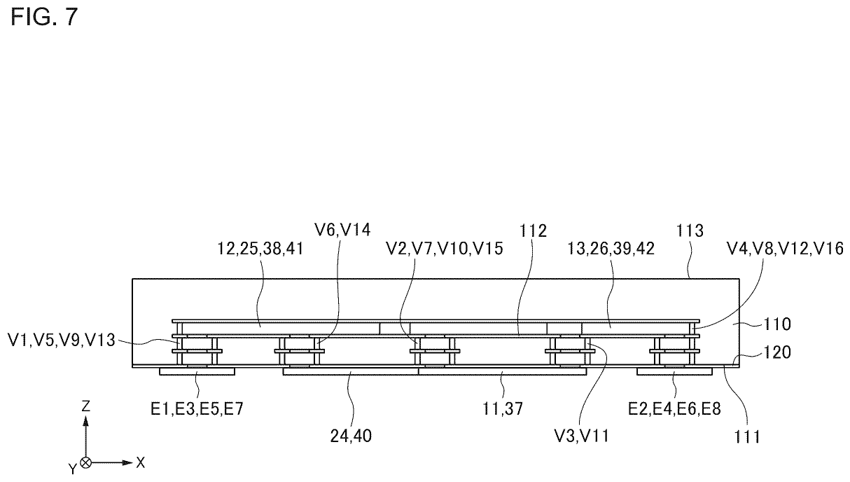

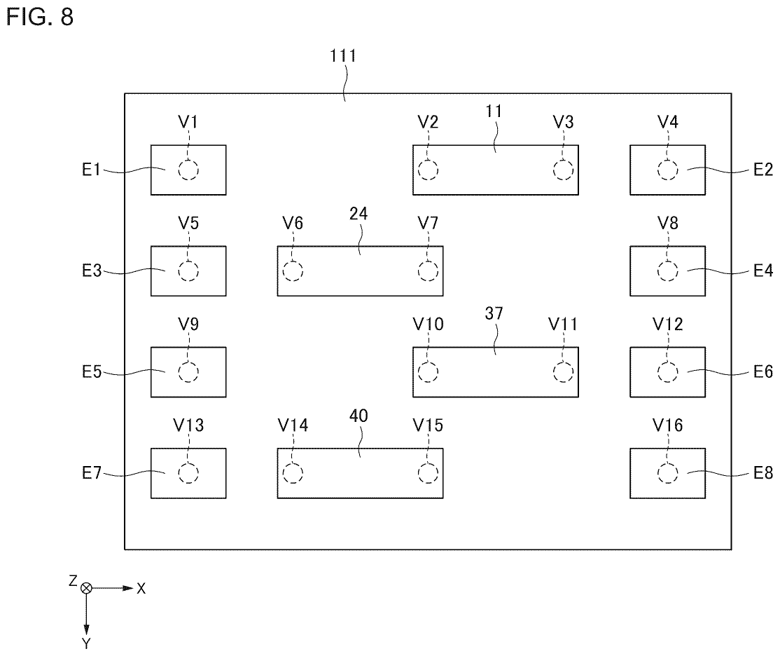

The inductances of the coils C1 to C4 can be adjusted by making a design change of the lengths of the conductor patterns 11, 24, 37, and 40 in the X-direction. For example, as illustrated in FIGS. 6, 7, and 8 which are a schematic transparent top view, a schematic transparent side view, and a schematic bottom view of the coil component according to a modification, an increase in the lengths of the conductor patterns 11, 24, 37, and 40 can further increase the inductances of the coils C1 to C4. In the example illustrated in FIGS. 6 to 8, the conductor patterns 11, 37 and conductor patterns 24, 40 partially overlap in the X-direction. Further, in the example of FIGS. 6 to 8, the positions of the via conductors V2, V7, V10, and V15 in the X-direction are mutually the same.

While some embodiments of the present disclosure has been described, the present disclosure is not limited to the above embodiment, and various modifications may be made within the scope of the present disclosure, and all such modifications are included in the present disclosure.

For example, although the coil component includes four coils C1 to C4 in the embodiment illustrated in FIGS. 1 to 4, the number of coils included in the electronic component (coil component) is not limited in the technology according to the present disclosure.

The technology according to the present disclosure includes the following configuration examples but not limited thereto.

An electronic component according an aspect of the present disclosure includes: an element body having first and second surfaces extending in a first direction and a second direction perpendicular to the first direction, the first surface being different in position in a third direction perpendicular to the first and second directions from the second surface; first and second terminal electrodes formed on the first surface and arranged in the first direction; third and fourth terminal electrodes formed on the first surface and arranged in the first direction; a first coil having one end electrically connected to the first terminal electrode and the other end electrically connected to the second terminal electrode; and a second coil having one end electrically connected to the third terminal electrode and the other end electrically connected to the fourth terminal electrode. The first coil includes: a first conductor pattern formed on the first surface so as to extend in the first direction and having one end positioned on the first terminal electrode side and the other end positioned on the second terminal electrode side; a second conductor pattern formed on the second surface and having one end electrically connected to the first terminal electrode and the other end electrically connected to the other end of the first conductor pattern; and a third conductor pattern formed on the second surface and having one end electrically connected to the second terminal electrode and the other end electrically connected to the one end of the first conductor pattern. The second coil includes: a fourth conductor pattern formed on the first surface so as to extend in the first direction and having one end positioned on the third terminal electrode side and the other end positioned on the fourth terminal electrode side; a fifth conductor pattern formed on the second surface and having one end electrically connected to the third terminal electrode and the other end electrically connected to the other end of the fourth conductor pattern; and a sixth conductor pattern formed on the second surface and having one end electrically connected to the fourth terminal electrode and the other end electrically connected to the one end of the fourth conductor pattern. The first coil and the second coil are arranged adjacent to each other in the second direction, and the first conductor pattern and the fourth conductor pattern are formed at mutually different positions in the first direction. This can reduce the size of the element body in the second direction.

In the above electronic component, the first terminal electrode and the third terminal electrode may be arranged in the second direction, and the second terminal electrode and the fourth terminal electrode may be arranged in the second direction. This can reduce the size of the element body in the first direction.

In the above electronic component, the first conductor pattern may be linearly formed in the first direction, the second conductor pattern may be formed in a shape including a plurality of linear parts linearly formed in the first direction and at least one bent part connecting the plurality of linear parts and bent in the second direction, the third conductor pattern may be formed in a shape including a linear part linearly formed in the first direction and at least one bent part bent in the second direction, the fourth conductor pattern may be linearly formed in the first direction, the fifth conductor pattern may be formed in a shape including a plurality of linear parts linearly formed in the first direction and at least one bent part connecting the plurality of linear parts and bent in the second direction, and the sixth conductor pattern may be formed in a shape including a linear part linearly formed in the first direction and at least one bent part bent in the second direction. This can further reduce the size of the element body in the second direction.

In the above electronic component, the first terminal electrode and the one end of the second conductor pattern may be electrically connected through a first via conductor formed in the third direction, the one end of the first conductor pattern and the other end of the third conductor pattern may be electrically connected through a second via conductor formed in the third direction, the other end of the first conductor pattern and the other end of the second conductor pattern may be electrically connected through a third via formed in the third direction, the second terminal electrode and the one end of the third conductor pattern may be electrically connected through a fourth via formed in the third direction, the third terminal electrode and the one end of the fifth conductor pattern may be electrically connected through a fifth via conductor formed in the third direction, the one end of the fourth conductor pattern and the other end of the sixth conductor pattern may be electrically connected through a sixth via conductor formed in the third direction, the other end of the fourth conductor pattern and the other end of the fifth conductor pattern may be electrically connected through a seventh via formed in the third direction, the fourth terminal electrode and the one end of the sixth conductor pattern may be electrically connected through an eighth via formed in the third direction, the first to fourth via conductors may be arranged in this order in the first direction, and the fifth to eighth via conductor may be arranged in this order in the first direction. This can reduce the size of the element body in the second direction.

In the above electronic component, the first conductor pattern and the fourth conductor pattern may be formed so as not to overlap each other in the first direction. This can further reduce the size of the element body in the second direction.

In the above electronic component, the second via conductor and the seventh via conductor may be formed at different positions in the first direction. This can further reduce the size of the element body in the second direction.

In the above electronic component, the first conductor pattern and the fourth conductor pattern may be formed so as to partially overlap each other in the first direction. This can achieve a larger inductance.

In the above electronic component, the positions of the second via conductor and the seventh via conductor in the first direction may coincide with each other. This can achieve a larger inductance.

In the above electronic component, the first coil may have a core which is surrounded, in a side view as viewed in the second direction, by the first conductor pattern, the second via conductor, the third via conductor, a part of the second conductor pattern that is located between the second via conductor and the third via conductor in the first direction, and a part of the third conductor pattern that is located between the second via conductor and the third via conductor in the first direction, the second coil may have a core which is surrounded, in a side view as viewed in the second direction, by the fourth conductor pattern, the sixth via conductor, the seventh via conductor, a part of the fifth conductor pattern that is located between the sixth via conductor and the seventh via conductor in the first direction, and a part of the sixth conductor pattern that is located between the sixth via conductor and the seventh via conductor in the first direction, and a center axis of the core of the first coil in the second direction and a center axis of the second coil in the second direction may not overlap in the first direction. This can further reduce the size of the element body in the second direction.

In the above electronic component, in a plan view as viewed in the third direction, an area surrounded by the part of the second conductor pattern that is located between the second via conductor and the third via conductor in the first direction and the part of the third conductor pattern that is located between the second via conductor and the third via conductor in the first direction may partially overlap the first conductor pattern, and an area surrounded by the part of the fifth conductor pattern that is located between the sixth via conductor and the seventh via conductor in the first direction and the part of the sixth conductor pattern that is located between the sixth via conductor and the seventh via conductor in the first direction may partially overlap the second conductor pattern. This can further reduce the size of the element body in the second direction.

In the above electronic component, the first coil and the second coil may be line-symmetric with respect to a symmetry axis that passes through the center thereof in the first direction and extends in the second direction. This can make the inductances of the first and second coils coincide with each other easily and facilitates design.

The above electronic component may further include fifth and sixth terminal electrodes formed on the first surface and arranged in the first direction and a third coil having one end electrically connected to the fifth terminal electrode and other end electrically connected to the sixth terminal electrode, the third coil may include a seventh conductor pattern which is formed on the first surface so as to extend in the first direction and having one end positioned on the fifth terminal electrode side and other end positioned on the sixth terminal electrode side, an eighth conductor pattern which is formed on the second surface and having one end electrically connected to the fifth terminal electrode and other end electrically connected to the other end of the seventh conductor pattern, and a ninth conductor pattern which is formed on the second surface and having one end electrically connected to the sixth terminal electrode and other end electrically connected to the one end of the seventh conductor pattern, the second coil and the third coil may be arranged adjacent to each other in the second direction, and the fourth conductor pattern and the seventh conductor pattern may be formed at mutually different positions in the first direction. Thus, there can be provided an electronic component provided with a coil array including three coils.

In the above electronic component, the positions of the first conductor pattern and the seventh conductor pattern in the first direction may coincide with each other. This facilitates pattern design.

In the above electronic component, the first, third, and fifth terminal electrodes may be arranged in this order in the second direction, the second, fourth, and sixth terminal electrodes may be arranged in this order in the second direction, and the first coil and the third coil may be symmetric with respect to a symmetry axis that passes through the center in the second direction and extends in the first direction. This can make the inductances of the first and third coils coincide with each other easily and facilitates design.

The above electronic component may further include seventh and eighth terminal electrodes formed on the first surface and arranged in the first direction and a fourth coil having one end electrically connected to the seventh terminal electrode and other end electrically connected to the eighth terminal electrode, the fourth coil may include a tenth conductor pattern which is formed on the first surface so as to extend in the first direction and having one end positioned on the seventh terminal electrode side and other end positioned on the eighth terminal electrode side, an eleventh conductor pattern which is formed on the second surface and having one end electrically connected to the seventh terminal electrode and other end electrically connected to the other end of the tenth conductor pattern, and a twelfth conductor pattern which is formed on the second surface and having one end electrically connected to the eighth terminal electrode and other end electrically connected to the one end of the tenth conductor pattern, the third coil and the fourth coil may be arranged adjacent to each other in the second direction, and the seventh conductor pattern and the tenth conductor pattern may be formed at mutually different positions in the first direction. Thus, there can be provided an electronic component provided with a coil array including four coils.

In the above electronic component, the first, third, fifth, and seventh terminal electrodes may be arranged in this order in the second direction, the second, fourth, sixth, and eighth terminal electrodes may be arranged in this order in the second direction, the second coil and the fourth coil may be symmetric with respect to a symmetry axis that passes through the center in the second direction and extends in the first direction, and the third coil and the fourth coil may be symmetric with respect to a symmetry axis that passes through the center in the first direction and extends in the second direction. This can make the inductances of the second to fourth coils coincide with on another easily and facilitates design.

A circuit module according to an aspect of the present disclosure includes a substrate having first to fourth land patterns and the above-described electronic component mounted on the substrate, and the first to fourth terminal electrodes of the electronic component are connected respectively to the first to fourth land patterns. Thus, there can be provided a circuit module having an improved electronic component including a plurality of coils.

This application claims the benefit of Japanese Patent Application No. 2023-095558, filed on Jun. 9, 2023, the entire disclosure of which is incorporated by reference herein.

### REFERENCE SIGNS LIST

11-13, 24-26, 37-42 conductor pattern
51-56 linear part
61-68 bent part
100 coil component
100A mounting area
110 element body
111, 113 outer surface
112 inner layer surface
120 protective film
130 substrate
200 circuit module
C1-C4 coil
E1-E8 terminal electrode
L0-L4 virtual line
P1-P8 land pattern
Q1-Q4 intersection
V1-V16 via conductor

1. An electronic component comprising:
an element body having first and second surfaces extending in a first direction and a second direction perpendicular to the first direction, the first surface being different in position in a third direction perpendicular to the first and second directions from the second surface;
first and second terminal electrodes formed on the first surface and arranged in the first direction;
third and fourth terminal electrodes formed on the first surface and arranged in the first direction;
a first coil having one end electrically connected to the first terminal electrode and other end electrically connected to the second terminal electrode; and
a second coil having one end electrically connected to the third terminal electrode and other end electrically connected to the fourth terminal electrode,
wherein the first coil includes:
a first conductor pattern formed on the first surface so as to extend in the first direction and having one end positioned on the first terminal electrode side and other end positioned on the second terminal electrode side;
a second conductor pattern formed on the second surface and having one end electrically connected to the first terminal electrode and other end electrically connected to the other end of the first conductor pattern; and
a third conductor pattern formed on the second surface and having one end electrically connected to the second terminal electrode and other end electrically connected to the one end of the first conductor pattern,
wherein the second coil includes:
a fourth conductor pattern formed on the first surface so as to extend in the first direction and having one end positioned on the third terminal electrode side and other end positioned on the fourth terminal electrode side;
a fifth conductor pattern formed on the second surface and having one end electrically connected to the third terminal electrode and other end electrically connected to the other end of the fourth conductor pattern; and
a sixth conductor pattern formed on the second surface and having one end electrically connected to the fourth terminal electrode and other end electrically connected to the one end of the fourth conductor pattern,
wherein the first coil and the second coil are arranged adjacent to each other in the second direction, and
wherein the first conductor pattern and the fourth conductor pattern are formed at mutually different positions in the first direction.

2. The electronic component as claimed in claim 1,
wherein the first terminal electrode and the third terminal electrode are arranged in the second direction, and
wherein the second terminal electrode and the fourth terminal electrode are arranged in the second direction.

3. The electronic component as claimed in claim 2,
wherein the first conductor pattern is linearly formed in the first direction,
wherein the second conductor pattern is formed in a shape including a plurality of linear parts linearly formed in the first direction and at least one bent part connecting the plurality of linear parts and bent in the second direction,
wherein the third conductor pattern is formed in a shape including a linear part linearly formed in the first direction and at least one bent part bent in the second direction,
wherein the fourth conductor pattern is linearly formed in the first direction,
wherein the fifth conductor pattern is formed in a shape including a plurality of linear parts linearly formed in the first direction and at least one bent part connecting the plurality of linear parts and bent in the second direction, and
wherein the sixth conductor pattern is formed in a shape including a linear part linearly formed in the first direction and at least one bent part bent in the second direction.

4. The electronic component as claimed in claim 3,
wherein the first terminal electrode and the one end of the second conductor pattern are electrically connected through a first via conductor formed in the third direction,
wherein the one end of the first conductor pattern and the other end of the third conductor pattern are electrically connected through a second via conductor formed in the third direction,
wherein the other end of the first conductor pattern and the other end of the second conductor pattern are electrically connected through a third via formed in the third direction,
wherein the second terminal electrode and the one end of the third conductor pattern are electrically connected through a fourth via formed in the third direction,
wherein the third terminal electrode and the one end of the fifth conductor pattern are electrically connected through a fifth via conductor formed in the third direction,
wherein the one end of the fourth conductor pattern and the other end of the sixth conductor pattern are electrically connected through a sixth via conductor formed in the third direction,
wherein the other end of the fourth conductor pattern and the other end of the fifth conductor pattern are electrically connected through a seventh via formed in the third direction,
wherein the fourth terminal electrode and the one end of the sixth conductor pattern are electrically connected through an eighth via formed in the third direction,
wherein the first to fourth via conductors are arranged in this order in the first direction, and
wherein the fifth to eighth via conductor are arranged in this order in the first direction.

5. The electronic component as claimed in claim 4, wherein the first conductor pattern and the fourth conductor pattern are formed so as not to overlap each other in the first direction.

6. The electronic component as claimed in claim 5, wherein the second via conductor and the seventh via conductor are formed at different positions in the first direction.

7. The electronic component as claimed in claim 4, wherein the first conductor pattern and the fourth conductor pattern are formed so as to partially overlap each other in the first direction.

8. The electronic component as claimed in claim 7, wherein positions of the second via conductor and the seventh via conductor in the first direction coincide with each other.

9. The electronic component as claimed in claim 4,
wherein the first coil has a core which is surrounded, in a side view as viewed in the second direction, by the first conductor pattern, the second via conductor, the third via conductor, a part of the second conductor pattern that is located between the second via conductor and the third via conductor in the first direction, and a part of the third conductor pattern that is located between the second via conductor and the third via conductor in the first direction,
wherein the second coil has a core which is surrounded, in a side view as viewed in the second direction, by the fourth conductor pattern, the sixth via conductor, the seventh via conductor, a part of the fifth conductor pattern that is located between the sixth via conductor and the seventh via conductor in the first direction, and a part of the sixth conductor pattern that is located between the sixth via conductor and the seventh via conductors in the first direction, and
wherein a center axis of the core of the first coil in the second direction and a center axis of the second coil in the second direction do not overlap in the first direction.

10. The electronic component as claimed in claim 9,
wherein, in a plan view as viewed in the third direction,
an area surrounded by the part of the second conductor pattern that is located between the second via conductor and the third via conductor in the first direction and the part of the third conductor pattern that is located between the second via conductor and the third via conductor in the first direction partially overlap the first conductor pattern, and
an area surrounded by the part of the fifth conductor pattern that is located between the sixth via conductor and the seventh via conductors in the first direction and the part of the sixth conductor pattern that is located between the sixth via conductor and the seventh via conductor in the first direction partially overlap the second conductor pattern.

11. The electronic component as claimed in claim 1, wherein the first coil and the second coil are line-symmetric with respect to a symmetry axis that passes through a center thereof in the first direction and extends in the second direction.

12. The electronic component as claimed in claim 1, further comprising:
fifth and sixth terminal electrodes formed on the first surface and arranged in the first direction; and
a third coil having one end electrically connected to the fifth terminal electrode and other end electrically connected to the sixth terminal electrode,
wherein the third coil includes:
a seventh conductor pattern which is formed on the first surface so as to extend in the first direction and having one end positioned on the fifth terminal electrode side and other end positioned on the sixth terminal electrode side;
an eighth conductor pattern which is formed on the second surface and having one end electrically connected to the fifth terminal electrode and other end electrically connected to the other end of the seventh conductor pattern; and
a ninth conductor pattern which is formed on the second surface and having one end electrically connected to the sixth terminal electrode and other end electrically connected to the one end of the seventh conductor pattern,
wherein the second coil and the third coil are arranged adjacent to each other in the second direction, and
wherein the fourth conductor pattern and the seventh conductor pattern are formed at mutually different positions in the first direction.

13. The electronic component as claimed in claim 12, wherein positions of the first conductor pattern and the seventh conductor pattern in the first direction coincide with each other.

14. The electronic component as claimed in claim 12,
wherein the first, third, and fifth terminal electrodes are arranged in this order in the second direction,
wherein the second, fourth, and sixth terminal electrodes are arranged in this order in the second direction, and
wherein the first coil and the third coil are symmetric with respect to a symmetry axis that passes through a center in the second direction and extends in the first direction.

15. The electronic component as claimed in claim 12, further comprising:
seventh and eighth terminal electrodes formed on the first surface and arranged in the first direction; and
a fourth coil having one end electrically connected to the seventh terminal electrode and other end electrically connected to the eighth terminal electrode,
wherein the fourth coil includes:
a tenth conductor pattern which is formed on the first surface so as to extend in the first direction and having one end positioned on the seventh terminal electrode side and other end positioned on the eighth terminal electrode side;
an eleventh conductor pattern which is formed on the second surface and having one end electrically connected to the seventh terminal electrode and other end electrically connected to the other end of the tenth conductor pattern; and
a twelfth conductor pattern which is formed on the second surface and having one end electrically connected to the eighth terminal electrode and other end electrically connected to the one end of the tenth conductor pattern,
wherein the third coil and the fourth coil are arranged adjacent to each other in the second direction, and
wherein the seventh conductor pattern and the tenth conductor pattern are formed at mutually different positions in the first direction.

16. The electronic component as claimed in claim 15,
wherein the first, third, fifth, and seventh terminal electrodes are arranged in this order in the second direction,
wherein the second, fourth, sixth, and eighth terminal electrodes are arranged in this order in the second direction,
wherein the second coil and the fourth coil are symmetric with respect to a symmetry axis that passes through a center in the second direction and extends in the first direction, and
wherein the third coil and the fourth coil are symmetric with respect to a symmetry axis that passes through a center in the first direction and extends in the second direction.

17. A circuit module comprising:
a substrate having first to fourth land patterns; and
the electronic component as claimed in claim 1 mounted on the substrate,
wherein the first to fourth terminal electrodes of the electronic component are connected respectively to the first to fourth land patterns.
